(19) United States
(12) Patent Application Publication
(10) Pub. No.: US 2006/0113788 A1
(43) Pub. Date: Jun. 1, 2006

(54) Laser printable business form having a self laminating wristband and a self laminating strip label

(75) Inventor: James M. Riley, St. Louis, MO (US)

Correspondence Address: THOMPSON COBURN, LLP, ONE US BANK PLAZA, SUITE 3500, ST LOUIS, MO, 63101, US

(73) Assignee: Laser Band, LLC.

(21) Appl. No.: 10/999,244

(22) Filed: Nov. 30, 2004

(51) Int. Cl. B42D 15/00

(52) U.S. Cl. 283/81

(57) ABSTRACT

An approximately page sized form comprised of a face ply and a laminate ply has a self laminating wristband with extender in one area of the form and a strip label for labeling a file folder along with a plurality of self adhering labels and an over-sized self adhering label in another area. A layer of patterned adhesive/release separates the two plies in a relatively thin construction so that the form may be printed in one pass through a laser printer for an individual being admitted to a health care facility or the like. In this one form is found the individual elements routinely needed to admit a patient including setting up an associated paper file with common information entered only once to make in-processing of a patient quicker, more accurate and more efficient.

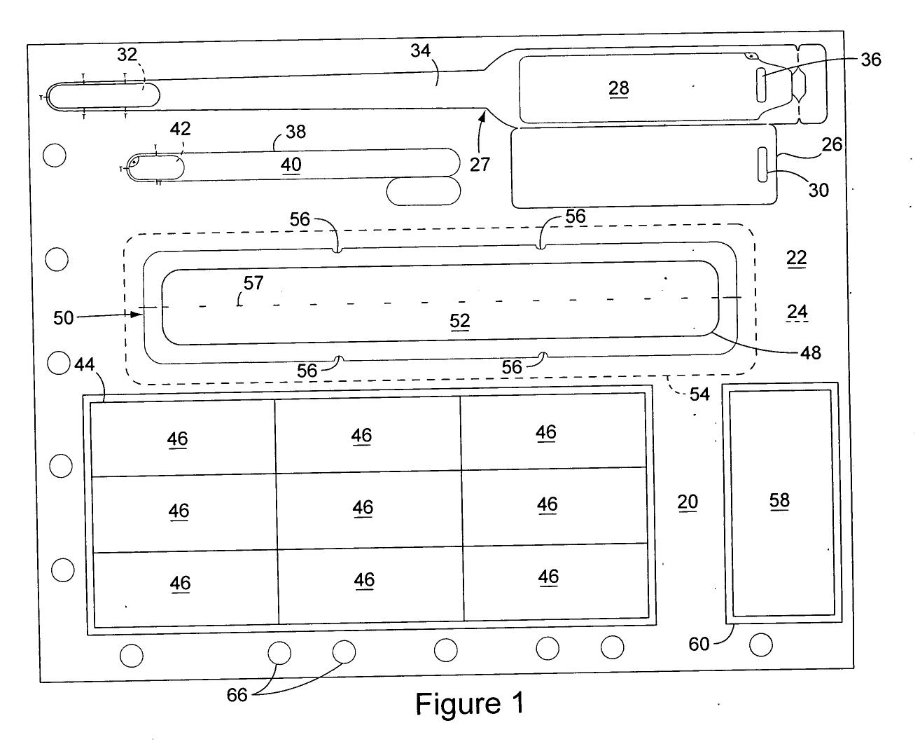

### BACKGROUND AND SUMMARY OF THE INVENTION

With the changing demographics of the population, there is an ever increasing need for health care services. This need translates to a need for the efficient processing of patients into a health care facility, such as a hospital, nursing home, emergency room, outpatient clinic, independently operated specialty care sections within hospitals, etc. There is also a need in other applications for the efficient processing of individuals into a group of people or other controlled environment, such as children into a school, inmates into a prison, etc. In many of these situations, there is a need to identify the individual and associate that individual with a document file or file folder of some kind. There may also be other items such as charts, test forms, etc. that need to be associated or linked to the respective individual. This creates the need for identifying bracelets or wristbands and associated labels. As a step forward in satisfying this need, the present inventor is also the inventor of several wristband forms which are die cut into two ply forms which are laser printable and which are self laminating. Another of his inventions includes combining these wristband forms with self adhering labels, all in the same page sized sheet and suitable for processing with a laser printer. Examples of his prior issued patents disclosing and claiming these inventions include U.S. Pat. No. 5,933,993; 6,000,160; 6,067,739; 6,438,881; 6,510,634; the disclosures of which are incorporated herein by reference. Additional patent applications related to these are pending. These inventions have met with great commercial success.

While the self adhering labels also found in the same page sized sheet may be used by being applied to a file folder, these labels are typically not wide enough to cover both sides of a standard-sized manila folder tab nor are they laminated and thus suffer from the shortcomings ordinarily experienced with unprotected paper in a health care or other harsh environment. The inventor herein, having recognized these shortcomings previously, is also the inventor of a strip label that is self laminating and which is comprised of two plies making it suitable for printing in one pass through a laser printer, or the like. That strip label invention is described in greater detail in the inventor's previously issued U.S. Pat. No. 6,685,228 and patent application published as Patent Application Number 20040109969, on Jun. 10, 2004, the disclosures of which are incorporated herein by reference. As defined therein, a strip label is generally considered as being a self adhering strip which is approximately twice as wide as the tab on a typical file folder and printable on both sides so as to be able to adhere to and cover both sides of the tab. The particular strip label design disclosed in the referenced issued patent and published patent application has significant advantages and features not found in the prior art and satisfies a particular need not otherwise met by the prior art.

In order to further simplify and streamline the processing and admission of individuals into health care and other facilities, or otherwise being processed into groups where the individual's identity and association with a document or paper file is required, the inventor has succeeded in creating a new design business form that satisfies this need. In essence, the present invention comprises a two ply form with a top face ply and a bottom laminate ply and a patterned adhesive/release layer separating the two plies. In the form, various die cuts are made in either one or both of the plies to form a detachable wristband and a detachable file folder label or strip label as that term is used herein. In its broadest sense, a strip label as that term is used herein can be considered as defined above. While in the preferred embodiment the inventor has chosen to use one of his self laminating wristband designs and his strip label design as disclosed and claimed in his earlier patent filings, the present invention is broadly meant to cover the mere combination of any style wristband and strip label in the same page sized form for printing with one pass through a laser or other printer. With this combination, an admissions clerk has the capacity to create a custom printed wristband and label an associated file folder. Still another advantage is that the individual's personal information need only be entered, and double checked, once to ensure that all the various items printed are accurate and are not mis-identified or incorrectly labeled. This is a significant advantage over the prior art as each time a form has to be processed almost without fail the individual's personal information must be re-entered thereby leading to possible mistake. As further enhancements to the present invention, the real estate of the form may be taken advantage of to provide a matrix of self adhering labels, a wristband extender, a larger sized label, and lesser other features.

By combining a wristband and a strip label into the same page sized form, a single sheet form may be provided for satisfying admission needs at health care facilities, hospitals, schools, prisons, etc. As the form is comprised of just two plies, the top ply of which is a face ply of paper stock or the like, it is readily processed in one pass through a laser printer or the like so that not only processing time but also costs are reduced tremendously over other arrangements of separate forms or the like presently in use in the prior art. Furthermore, in the preferred embodiment, each of the wristband and strip label provide the latest advantages of the inventor's previous patented designs including most especially the self laminating feature. Added to the versatility of the form is the commonly needed self adhering labels, wristband extender, larger self adhering label, and lesser other features which if not used may be discarded without significant waste or expense.

While many advantages and features of the present invention have been described above, reference should be made to the drawings and description of the preferred embodiment which follow in order to gain a fuller understanding of the present invention.

### BRIEF DESCRIPTION OF THE DRAWING

The drawing FIGURE is a top view of the business form of the present invention showing the layout of the wristband and extender, the strip label, the matrix of self adhering labels, and larger sized self adhering label.

### DETAILED DESCRIPTION OF THE PREFERRED EMBODIMENT

As shown in the drawing, the business form 20 of the present invention comprises a page sized form constructed of two plies separated by a layer of patterned adhesive/release as is taught in the inventor's previous patent filings. The top or face ply 22 is a paper stock suitable for receiving an image such as for example from a laser printer or the like. The bottom or laminate ply 24 is a transparent polyester or other such film material as would be suitable for over-laminating the face stock. A die cut 26 extending through both of the face ply 22 and the laminate ply 24 defines a self laminating wristband 27 as is explained in greater detail in several of the inventor's previous patent filings noted above. In short, the wristband 27 includes an imaging portion 28 formed in the face ply 22, and a laminating portion with cinch 30 formed in the laminate ply 24. A patch of adhesive 32 is provided at the end of a strap portion 34 for adhering the strap portion 34 to itself after it is threaded through the cinch slots 36 forming the cinch 30. Another die cut 38 forms a wristband extender 40 in the laminate ply 24, and it also has a patch of adhesive 42 at its end for attachment to the wristband 27 after the extender 40 is attached to the strap portion 34.

On the lower portion of the form 20, still another die cut 44 defines a matrix of nine self adhering labels 46 which may be peeled away from the form and adhered to other surfaces such as charts or the like. Yet another die cut 48 defines a strip label 50 with an imaging portion 52 in the face ply 22 and a laminating portion 54 in the laminate ply 24. Two pairs of notches 56 are formed in the face ply 22 as an aid in lining up the imaging portion 52 with the laminating portion 54, and a center fold line 57 is provided in the strip label 50 as an aid in folding it in half as it is applied to the file folder. More detailed explanations of the strip label 50 and its use are found in the inventor's previously issued patent and published patent application, referenced above. Briefly, however, the imaging portion 52 may be printed by a laser printer with the individual's name, social security number or other identifying indicia, a bar code, etc., and then it may be first separated from the form, reversed, and then replaced back into its space in the form. The two pairs of notches 56 are helpful in lining it up, as explained above and in the related published patent application. The laminating portion 54 may then be separated from the form and the imaging portion 52 comes along with it as the two are adhered to each other. The strip label 50 may then be applied to the tab or edge of a file folder and provide a laminated label which can be conveniently used to order and file multiple file folders for multiple individuals.

Lastly, a larger or over-sized self adhering label 58 is defined by yet another die cut 60. The over-sized label 58 may be applied to a chart where it may be viewed, such as at a hospital bed, applied to the spine of a binder or notebook, etc. Again, this over-sized label 58 has been found to be needed and used in many such applications so that providing it as part of a single form has been found to satisfy virtually the entirety of needs to “in-process” or admit a health care patient.

To assist in retaining the form 20, or portions of the form, in an ordered manner for their future use, a plurality of holes 66 are preferably provided along both of the narrow and the long edge of the form to fit standard ring binders of various ring or other fastener configurations.

The foregoing explanation of the invention in terms of an illustrative drawing and description of a preferred embodiment has been provided as an example of the invention and is not intended to be limiting in any way. Instead the invention should be considered as that which is encompassed by the scope of the following claims and their legal equivalents. Various changes and modification are within the scope of the present invention including providing wristbands of different construction or design, strip labels of different construction or design, different arrangements of the various elements of the form on the page sized sheet, different sizes for the page sized sheet including without limitation envelope or sheetlet size, the use of more than two plies for the form, different combinations of elements or elimination of some one or more elements from the form, and other similar and dissimilar changes.

What is claimed is:

1. A business form comprising a multi-ply sheet having a wristband and a strip label die cut therein and separable therefrom.

2. The business form of claim 1 wherein said wristband is self laminating.

3. The business form of claim 2 wherein said sheet comprises a face ply and a lamination ply, and a patterned layer of adhesive and release joining said face ply and said lamination ply.

4. The business form of claim 3 further comprising a plurality of self adhering labels die cut therein.

5. The business form of claim 4 wherein said strip label is self laminating.

6. The business form of claim 5 wherein said strip label has a plurality of self aligning marks to facilitate alignment of different plies of said strip label as it is laminated.

7. The business form of claim 6 further comprising a wristband extender die cut therein.

8. The business form of claim 7 further comprising an over-sized self adhering label die cut into both of said plies.

9. The business form of claim 8 wherein said wristband and said wristband extender is oriented at one side of said form.

10. A page sized business form comprising a face ply and a lamination ply, a first die cut forming a self laminating wristband, and a second die cut forming a self laminating strip label in said form.

11. The business form of claim 10 further comprising a third die cut forming a plurality of self adhering labels in said form.

12. The business form of claim 11 further comprising a fourth die cut forming an over-sized self adhering label in said form.

13. The business form of claim 12 further comprising a fifth die cut forming a wristband extender in said form.

14. The business form of claim 13 further comprising a fold line die cut into said strip label to aid in applying the strip label to a file folder or the like.

15. The business form of claim 14 further comprising a plurality of holes die cut into an edge of said form to facilitate the storing of the form in a ring binder.

16. A business form comprising a face ply layer and a lamination layer, the form having a die cut defining a self laminating wristband with an imaging portion formed in the face ply layer and a cinch attachment formed in the lamination layer, and a second die cut forming a strip label having an imaging portion formed in the face ply layer and a laminating portion formed in the lamination ply layer.

17. The business form of claim 16 wherein the strip label is self laminating.

18. The business form of claim 17 further comprising a third die cut forming a plurality of self adhering labels each of which having an imaging portion formed in the face ply layer.

19. The business form of claim 18 further comprising a fourth die cut forming an over-sized self adhering label having an imaging portion formed in the face ply portion.

20. The business form of claim 19 wherein said form is approximately page sized, and further comprising a fold line formed in the strip label.

21. The business form of claim 20 further comprising a fifth die cut forming a wristband extender.

22. An approximately page sized business form comprising a face ply and a lamination ply with a layer of patterned adhesive separating said face ply and said lamination ply, a die cut defining a self laminating wristband having an imaging portion in said face ply and a laminating portion including a cinch attachment in said lamination ply, and a second die cut forming a strip label in said form.

23. The business form of claim 22 wherein said strip label includes a laminating portion formed in said lamination ply.

24. The business form of claim 23 further comprising a die cut defining a plurality of self adhering labels in said form.
